(19) United States
(12) Patent Application Publication
(10) Pub. No.: US 2003/0126933 A1
(43) Pub. Date: Jul. 10, 2003

(54) Method for regulating the contact force between a pantograph and an overhead cable

(76) Inventors: Manfred Rode, Wiesloch (DE); Karl Jager, Immenstaad (DE)

Correspondence Address: HOWREY SIMON ARNOLD & WHITE, CITYPOINT, ONE ROPEMAKER STREET, LONDON, EC2Y 9HS, GB

(21) Appl. No.: 10/203,888

(22) PCT Filed: Feb. 15, 2001
(86) PCT No.: PCT/EP01/01714

(30) Foreign Application Priority Data
Feb. 17, 2000 (DE) 10007287.9

(51) Int. Cl. G01L 5/00; G01L 1/00

(52) U.S. Cl. 73/862.381

(57) ABSTRACT

A method for regulating the contact force between a pentograph and an overhead cable, by means of at least two contact force measuring sensors for determining the contact force is disclosed, whereby the drop-out of a contact force measuring sensor is determined from the contact force measured signals (y1, y2). A comparison can be made between the current average quadratic deviation ((a) or cov(ys)) derived from the measured values (y1, y2) and the average quadratic deviation in an undisturbed nominal case ((b) or con(ys)ₒ) and the above used for detection of the drop-out of a contact force measuring sensor, or, alternatively a comparison can be made between the current average amount of the derivation (PT1(|ys-X|2.5s)) derived from the measured values (y1, y2) and the average amount of the deviation in the undisturbed nominal case (PT1(|ys-X|2.5s)_{q}) and the above used for detection of the drop-out of a contact force measuring sensor.

### DESCRIPTION

The invention relates to a method for regulating the contact force between a pantograph and an overhead cable according to the preamble of claim 1.

Devices/methods for measuring the contact force by means of a contact-force measuring sensor (contact force measurement) and devices/methods for regulating the contact force between the pantograph and overhead cable/overhead line of a rail system (contact force regulating system) are generally known. Here, the problem of a failure of a contact-force measuring sensor when measuring and regulating the contact force Is not investigated although fail safety is very important when regulating the contact force between the pantograph and overhead line, and this is because a failure of a contact-force measuring sensor has considerable effects/reactions on the contact force set and on the regulation of the contact force between the pantograph and overhead cable owing to the contact force which is derived from the contact-force measured signals. A failure of a contact-force measuring sensor can lead to a situation in which the advantages of the contact-force regulating system are reversed, i.e. when a contact-force measuring sensor fails a contact-force regulating system leads to a degradation of the contact-force characteristics in comparison to a situation in which it is not regulated.

The invention is based on the object of specifying an improved method for regulating the contact force between the pantograph and overhead cable.

This object is achieved according to the invention in conjunction with the features of the preamble by means of the features characterized in claim 1.

The advantages which can be achieved with the invention consist, in particular, in the fact that the proposed method for regulating the contact force between the pantograph and overhead cable considerably increases the overall reliability and quality of a contact-force measurement and contact-force regulating system. The conditions of the formation of measured signals to determine a measure of the current contact force are utilized in order to make a determination relating to the serviceability/disturbance of a contact-force measured signal, and a monitor is, as it were, created which checks the measuring system for the failure of a contact-force measuring sensor. Through the detection of a failure of a contact-force measuring sensor it is possible to intervene selectively in the measurement in order, in this way, to avoid negative reactions on the contact-force regulating system. It is advantageously not necessary to use redundant contact-force measuring sensors. The necessary computational outlay is not too high and can be implemented easily.

Advantageous refinements of the invention are characterized in the subclaims.

Further advantages of the proposed method for regulating the contact force between the pantograph and overhead cable emerge from the description below.

The invention is explained in more detail below with reference to the exemplary embodiments illustrated in the drawing, in which:

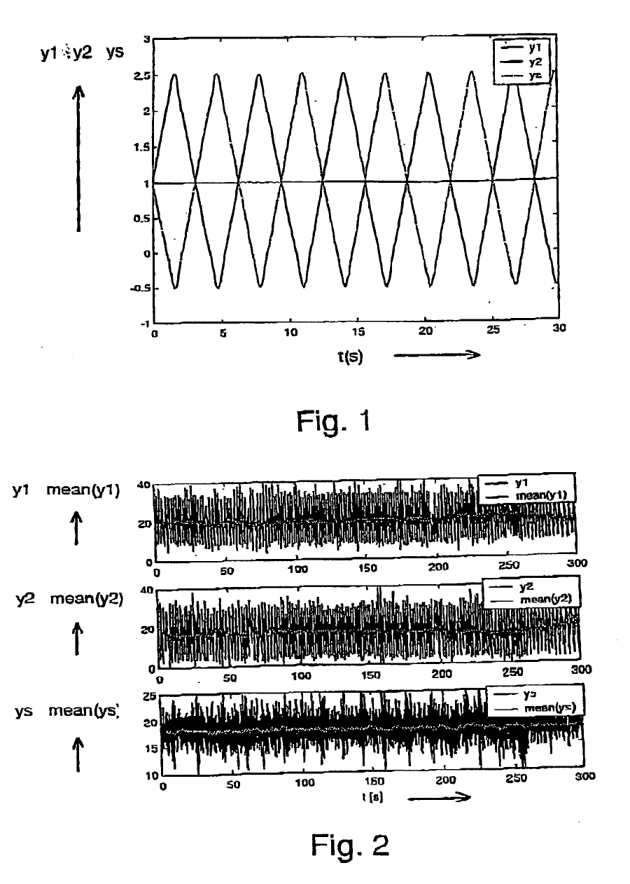

FIG. 1 shows the signal profiles over time of the two contact-force measured signals and of the averaged contact-force measured signal for ideal conditions,

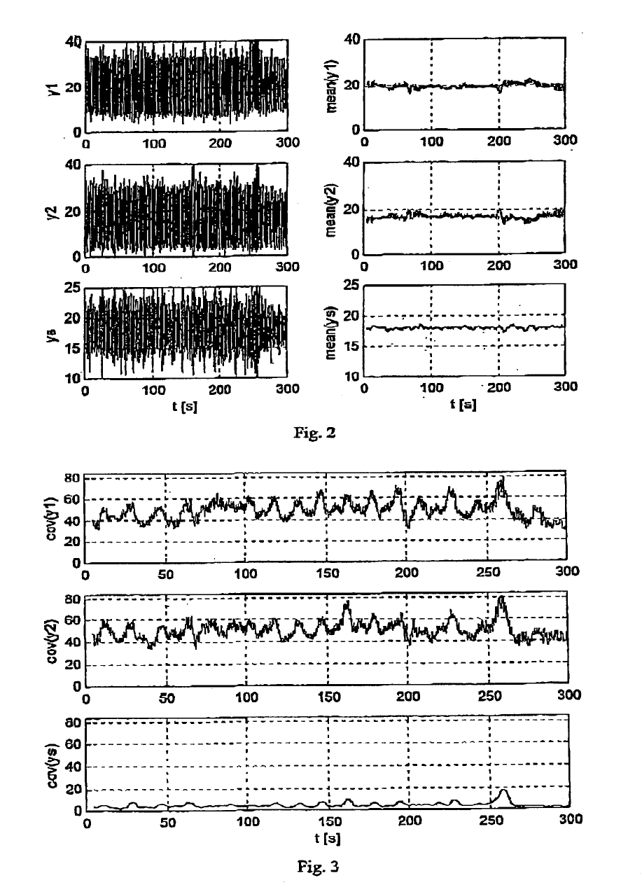

FIG. 2 shows the signal profiles over time of the two contact-force measured signals and of the contact-force measured signal mean values for real conditions,

FIG. 3 shows the mean square errors for real, measured contact-force measured signals,

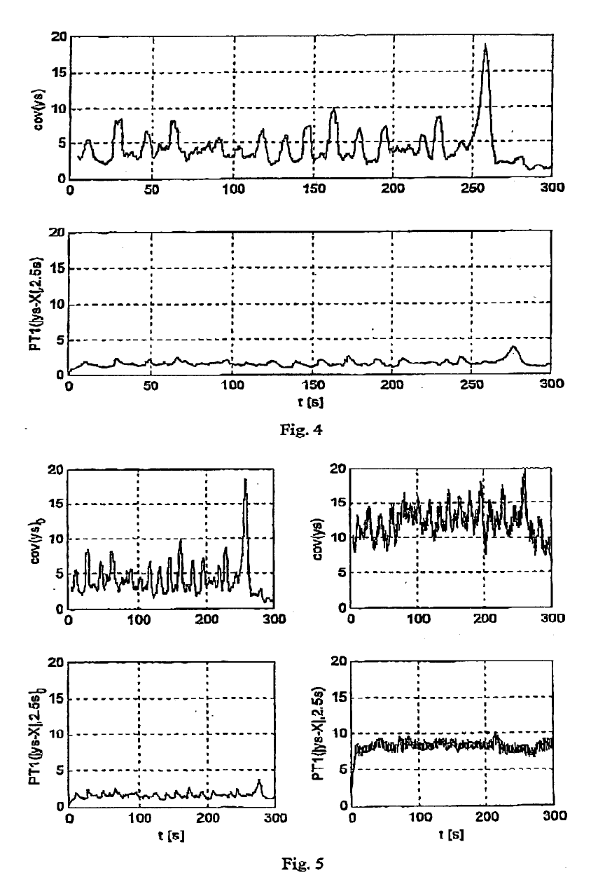

FIG. 4 shows a comparison of the mean square error and the mean error of absolute value,

FIG. 5 shows the situation according to FIG. 4 with a contact-force measuring sensor which has failed and which constantly supplies the value 0,

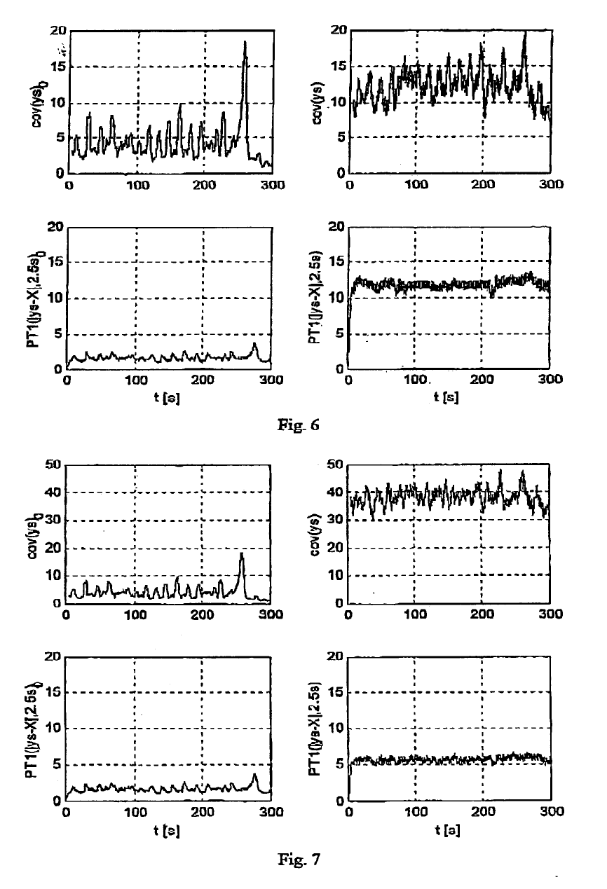

FIG. 6 shows the situation according to FIG. 4 with a contact-force measuring sensor which has failed and which constantly supplies the maximum value,

FIG. 7 shows the situation according to FIG. 4 with a contact-force measuring sensor which has failed and which constantly supplies white noise which is free of the mean value/has the mean value.

It is generally known to register the contact forces between the right-hand side of the pantograph rocker of the pantograph and overhead cable and the contact forces brought about between the left-hand side of the pantograph and overhead cable by means of separate contact-force measuring sensors. Owing to this constructional arrangement of the contact-force measuring sensors on the pantograph rocker and of the zigzag profile of the overhead line, a measure of the contact force can be obtained by averaging the deflections of the pantograph strip springs. The contact-force measured signal y1 of the first (for example right-hand) contact-force measuring sensor is:

y1=X±x1

The contact-force measured signal y2 of the second (for example left-hand) contact-force measuring sensor is

y2=x±x2

The contact-force measured signal ys which is averaged from y1, y2 is then:

ys−(y1+y2)/2

The two contact-force measured signals y1, y2, generally also yi (where i=1, 2) are obtained as an additive superimposition of the steady-state component X owing to the pretensioning of the pantograph strip and the dynamic components x1, x2 owing to the line zigzag of the overhead cable.

In FIG. 1 and FIG. 2, the signal profiles over time (t=time) of the contact-force measured signal y1, of the contact-force measured signal y2 and of the contact-force measured signal ys averaged from y1, y2 are represented for ideal conditions—see FIG. 1—and for real conditions—see FIG. 2. In FIG. 2, the measured—signal mean values mean(y1), mean(y2), mean(ys) are additionally entered.

The mean square error of the measured signal—by analogy with the random characteristic variable variance—is calculated as:

s²_{ys,k}=E{(ysₖ−x)²}

where E{. . . }=mean value of {. . . }

$$e . g . E \{ … \} = 1 / n {\sum }_{i - k - n + 1}^{k} {ys}_{i}$$

as a sliding mean value over the last n measured values.

k=running index for current measured value at the

time t=k*T, k=1, 2, . . .

where T sample step width.

Insertion of the formation rule for ys at the measuring time k yields:

s²_{ys,k}=E{(y1ₖ+y2ₖ)/2−X)²}=E{(0)²}

s²_{ys,k}=0 in the case in which the individual signals x1ₖ, x2ₖ are mirrored in the steady-state component X, x1ₖ=−x2ₖ.

Irrespective of whether the spring deflection or some other signal, acquired for example by means of direct contact force measurement, is used to form the contact-force measured signal, this relationship applies whenever the individual signals used are mirrored at the steady-stage component x. Asymmetries in y1 and y2 owing to maladjustments at the measuring pickup can be compensated by taking into account the offset causing asymmetry in the formation of ys.

The conditions for real, measured contact-force measured signals are represented in FIG. 3. Here, the mean square errors cov(y1) , cov(y2) of the individual signals and the mean square error cov(ys) of the averaged signal arc represented. The dynamic component xi is equivalent here to the variance s²_{ys}. The error s²_{ys}>0 is due to structural disturbances, which cannot be detected and resulting stochastic disturbances These can be taken into account in the signal description by means of an additive, stochastic (random-number-dependent) term eᵢ:

yi=X+xi+eᵢ,

where i=1, 2

If a contact-force measuring sensor fails, the condition s²_{ys}=0 is infringed—without a stochastic term. This applies both to the case in which the disturbed contact-force measuring sensor supplies a constant value (maximum value or 0) and to the one in which it supplies a stochastic noise. The mean square error from the steady-state value can thus be used as a measure of the detection of a failure or a contact-force measuring sensor.

The expenditure on equipment for detecting the failure of a contact-force measuring sensor can be reduced further by using the mean absolute value of the error instead of the mean square error.

A further simplification is obtained if the mean value—steady-state signal component—is not formed from the contact-force measured signals themselves but rather the predefined setpoint value of the regulating algorithm used for regulating the contact force is employed for this. This ensures per se chat the steady-state signal component corresponds on average to the predefined setpoint value.

FIG. 4 shows, in a contrasting arrangement, the mean square error cov(ys) and the mean error of the absolute value or the mean absolute value of the error PT1(|ys−X|2.5s), i.e. the interval square, filtered by means of PT1 filter (kₚ=1, T₁=2.5s), between the mean contact-force measured signal ys and the regulator setpoint value X.

Various cases of disturbance (a failed contact-force measuring sensor) are represented in FIGS. 5, 6 and 7. It is to be noted here that in the case of disturbance, the rise in the mean square error cov(ys) and also the mean error of the absolute value (mean absolute value of the error) PT1(|ys−x|2.5s), i.e. the PT1-filtered interval square changes significantly in comparison with the nominal case (index 0) with the mean square error cov(ys)ₐ, as does also the mean error of the absolute value (mean absolute value of the error) PT1(|ys−X|2.5s)₀.

FIGS. 5 and 6 show the situation with a failed contact-force measuring sensor, the failed contact-force measuring sensor according co FIG. 5 constantly supplying the value 0, and the failed contact-force measuring sensor according to FIG. 6 constantly supplying a maximum value. It is apparent that the variance s²_{ys0} and cov(ys) which occurs is in each case significantly above the “non-disturbed” variance (nominal case) s²_{ys0} or cov(ys)₀ which is also shown for the purpose of comparison.

FIG. 7 represents the situation with a failed sensor, the failed sensor not supplying a constant signal but rather white noise which is free of the mean value/has the mean value. In this case also, it is clearly apparent that it is possible to make a determination relating to the failure of a contact-force measuring sensor by reference to the sliding variance of the averaged contact-force measured signal.

It is thus easily possible to generate an effective measure for detecting the failure of a contact-force measuring sensor by filtering the mean absolute-value error from the setpoint value of the contact force of the pantograph strip.

The speed of the train is apparent in an expansion or compression of the contact-force measured signals and has a negative influence on the considerations explained above.

A determination of which of the two contact-force measuring sensors has failed can be made on the basis of the random characteristic variables by evaluating relatively high moments, for example skewing (measure of symmetry).

A further possibility for detecting a failure of a contact-force measuring sensor is spectrum analysis of the contact-force measured signals in order to check the serviceability of the contact-force measuring sensors by reference to the detected overhead line zigzag frequency.

1. Method for regulating the contact force between a pantograph and an overhead cable using at least two contact-force measuring sensors which determine the contact force, characterized in that the failure of a contact-force measuring sensor is detected from the contact-force measured signals (y1, y2).

2. Method according to claim 1, characterized in that the current mean square error (s²_{ya0} or cov(ys)) formed from the measured signals (y1, y2) is compared with the mean square error in an undisturbed nominal case (s²ys0 or cov(ys)₀) and used to detect the failure of a contact-force measuring sensor.

3. Method according to claim 1, characterized in that the current mean absolute value of the error (PT1(|ys−X|2.5s)) formed from the measured signals (y1, y2) is compared with the mean absolute value of the error in the undisturbed nominal case (PT1(|ys−X|2.5s)₀) and used to detect the failure of a contact-force measuring sensor.

4. Method according to claim 2 or 3, characterized in that the predefined setpoint value of the regulating algorithm used to regulate the contact force is used as a mean value or steady-state signal component.

5. Method according to claim 1, characterized in that the detection of the failure of a contact-force measuring sensor is carried out by means of a spectral analysis of the contact-force measured signals (y1, y2) with which the serviceability of the contact-force measuring sensors is checked by reference to the detected overhead line zigzag frequency.

6. Method according to one of the preceding claims, characterized in that which of the contact-force measuring sensors has failed i determined by evaluating relatively high moments, in particular skewing.
